(19) United States
(12) Patent Application Publication
(10) Pub. No.: US 2018/0324351 A1
(43) Pub. Date: Nov. 8, 2018

(54) CONTROL DEVICE, CONTROL METHOD, AND PROGRAM

(71) Applicant: SONY CORPORATION, TOKYO (JP)

(72) Inventor: AKIKO YOSHIMOTO, TOKYO (JP)

(73) Assignee: SONY CORPORATION, Tokyo (JP)

(21) Appl. No.: 15/773,061

(22) PCT Filed: Sep. 2, 2016
(86) PCT No.: PCT/JP2016/075899

§ 371 Date: May 2, 2018

(30) Foreign Application Priority Data
Nov. 17, 2015 (JP) 2015-224894

(51) Int. Cl. H04N 5/232; G06F 3/041; G06F 3/0488

(52) U.S. Cl. CPC H04N 5/23216; G06F 3/041; G06F 2203/0381; H04N 5/232933; H04N 5/232939; G06F 3/04886

(57) ABSTRACT

[Object] To provide a control device, control method, and program, capable of improving the operability of a touch operation while eliminating or reducing the erroneous detection of the touch operation. [Solution] A control device including: a determination unit configured to determine whether a touch-and-movement operation is valid across a valid area in which a touch operation on a display unit is treated as valid and an invalid area in which the touch operation is treated as invalid on a basis of whether a start point of the touch-and-movement operation is located within the valid area.

### TECHNICAL FIELD

The present disclosure relates to a control device, a control method, and a program.

### BACKGROUND ART

Digital cameras equipped with, in one example, a finder such as an electronic viewfinder (EVF) are now in widespread use. Such digital cameras make it possible for the user to easily determine the composition of a photographed image or adjust the focus thereof by looking through the finder.

Further, digital cameras equipped with a touch panel are also being developed. In one example, Patent Literatures 1 and 2 below disclose a technique of setting the central region of the rear display unit as a dead zone so that the contact of the user's nose with the rear display unit upon looking through the finder is prevented from being erroneously detected as a touch operation.

### CITATION LIST

### Patent Literature

Patent Literature 1: JP 2014-038195A

### DISCLOSURE OF INVENTION

### Technical Problem

The technique disclosed in Patent Literatures 1 and 2 however causes all the touch operations on the area of the dead zone that is set on the rear display unit to be invalid. Thus, in one example, when the touch position is moved from an area other than the dead zone to the dead zone, the touch operation will be restricted, for example, the touch operation is unexpectedly invalid.

In view of this, the present disclosure provides a novel and improved control device, control method, and program, capable of improving the operability of a touch operation while eliminating or reducing the erroneous detection of the touch operation.

### Solution to Problem

According to the present disclosure, there is provided a control device including: a determination unit configured to determine whether a touch-and-movement operation is valid across a valid area in which a touch operation on a display unit is treated as valid and an invalid area in which the touch operation is treated as invalid on a basis of whether a start point of the touch-and-movement operation is located within the valid area.

In addition, according to the present disclosure, there is provided a control method including: determining whether a touch-and-movement operation is valid across a valid area in which a touch operation on a display unit is treated as valid and an invalid area in which the touch operation is treated as invalid on a basis of whether a start point of the touch-and-movement operation is located within the valid area.

In addition, according to the present disclosure, there is provided a program causing a computer to function as: a determination unit configured to determine whether a touch-and-movement operation is valid across a valid area in which a touch operation on a display unit is treated as valid and an invalid area in which the touch operation is treated as invalid on a basis of whether a start point of the touch-and-movement operation is located within the valid area.

### Advantageous Effects of Invention

According to the present disclosure as described above, it is possible to improve the operability of the touch operation while eliminating or reducing the erroneous detection of the touch operation. Moreover, the effects described herein are not necessarily restrictive, or there may be any effect set forth herein.

### BRIEF DESCRIPTION OF DRAWINGS

FIG. 1 is a diagram illustrated to describe how a user takes a picture with a photographing device 10 according to an embodiment of the present disclosure.

FIG. 2 is a diagram illustrated to describe how a user performs a touch operation on an operation display unit 126 while bringing the eye close to an EVF 122.

FIG. 3 is a functional block diagram illustrating an internal configuration of the photographing device 10 according to the present embodiment.

FIG. 4 is a diagram illustrated to describe an example of setting a valid setting area according to the present embodiment.

FIG. 5 is a diagram illustrated to describe an example of setting a valid setting area according to the present embodiment.

FIG. 6 is a diagram illustrated to describe an example of a drag operation on the operation display unit 126.

FIG. 7 is a diagram illustrated to describe an example of the drag operation on the operation display unit 126.

FIG. 8 is a diagram illustrated to describe an example of the drag operation on the operation display unit 126

FIG. 9 is a diagram illustrated to describe an example of the drag operation on the operation display unit 126.

FIG. 10 is a diagram illustrated to describe an example in which a display position of an autofocus (AF) frame is moved on the basis of the drag operation.

FIG. 11 is a diagram illustrated to describe an example in which a display position of an image being displayed in an enlarged manner is moved on the basis of the drag operation.

FIG. 12 is a flowchart illustrating an operation example according to the present embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, components that have substantially the same function and structure are denoted with the same reference numerals, and repeated explanation of these components is omitted.

Further, there is also a case where, in the present specification and drawings, a plurality of components having substantially the same functional configuration as each other are distinguished by addition of an alphabetic suffix. In one example, a plurality of configurations having substantially the same functional configuration as each other are distinguished, for example, a touch position 30a and a touch position 30b, as necessary. However, in the case where it is not necessary to particularly distinguish each of a plurality of components having substantially the same functional configuration, only the same reference numeral is provided. In one example, in the case where it is not necessary to particularly distinguish between the touch position 30a and the touch position 30b, they are simply referred to as a touch position 30.

Moreover, the “mode for carrying out the invention” will be described according to the order of listing shown below.

1. Basic configuration of photographing device 10
2. Detailed description of embodiment
3. Modified examples

### 1. Basic Configuration of Photographing Device 10

### 1-1. Basic Configuration

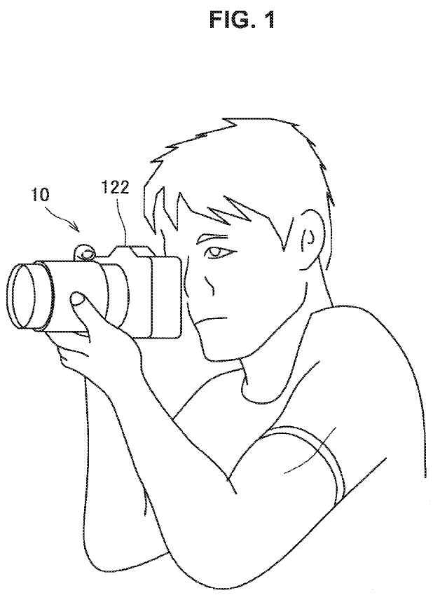

The basic configuration of a photographing device 10 according to an embodiment of the present disclosure is now described with reference to FIG. 1. FIG. 1 is a diagram illustrated to describe how the user takes a picture with the photographing device 10.

The photographing device 10 is an example of a control device according to the present disclosure. The photographing device 10 is a device for capturing a picture of the external environment or reproducing an image. Here, photography is actually to record an image or to display a monitor image.

Further, the photographing device 10 includes a finder. Here, the finder is, in one example, a viewing window used to find a composition before photographing and adjust the focus, by allowing the user to bring the eyes close to it (hereinafter sometimes referred to as “look through”). In one example, as illustrated in FIG. 1, the finder is an EVF 122. The EVF 122 displays image information acquired by an image sensor (not shown) included in the photographing device 10.

The finder, however, although not limited to such an example, may be an optical viewfinder. Moreover, the following description is given by focusing on an example in which the finder (included in the photographing device 10) is the EVF 122.

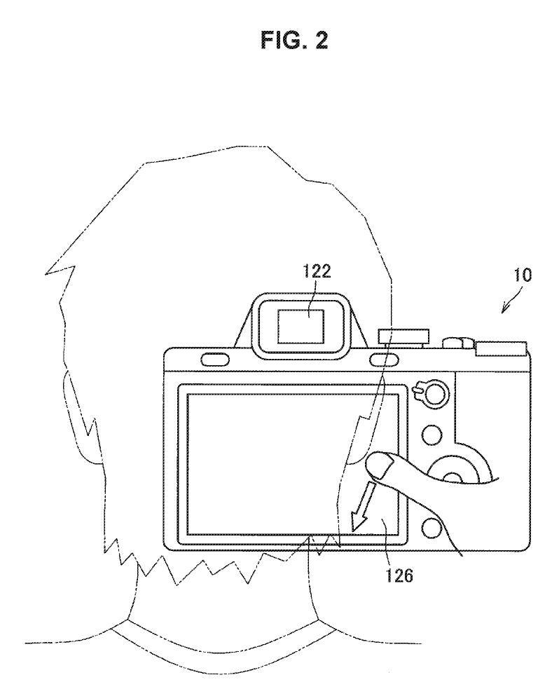

Further, the photographing device 10 includes an operation display unit 126, in one example, on the rear side of the housing, as illustrated in FIG. 2. The operation display unit 126 has a function as a display unit that displays various types of information such as photographed images and an operation unit that detects an operation by the user. The function as the display unit is implemented by, in one example, a liquid crystal display (LCD) device, an organic light emitting diode (OLED) device, or the like. In addition, the function as the operation unit is implemented by, in one example, a touch panel.

Here, a touch operation on the operation display unit 126 is not limited to an operation based on contact, but may be a proximity operation (an operation based on determination on proximity to the operation display unit 126). Moreover, the following description is given of an example in which the touch operation is an operation based on the contact on the operation display unit 126.

### 1-2. Summary of Problem

Meanwhile, as illustrated in FIG. 2, in a case where the user's eye approaches the EVF 122, the user's nose strikes the operation display unit 126 or the finger of the user's left hand holding the photographing device 10 touches the operation display unit 126 in some cases without the intention of the user. In this case, the photographing device 10 erroneously detects the contact of the nose or the left hand's finger with the operation display unit 126 as the touch operation, resulting in execution of the processing based on the erroneously detected operation.

Thus, a solution is conceivable in which only a part of the operation display unit 126 is set as an area where the touch operation is treated as valid (hereinafter referred to as a touch valid area) (or an area where the touch operation is treated as invalid (hereinafter referred to as touch invalid area)) to eliminate or reduce the erroneous detection of an operation. According to this solution, even if the nose strikes an area other than the touch valid area or the left hand's finger unintentionally touches the area other than the touch valid area, it is not detected as an operation. Here, the touch valid area is an example of a valid area in the present disclosure, and the touch invalid area is an example of an invalid area in the present disclosure.

Meanwhile, as a method of setting the touch valid area, in one example, a method of uniformly setting a predetermined area such as the right half on the operation display unit 126 as the touch valid area is conceivable. However, in one example, the position or shape of the nose varies depending on the user, and whether to look through the EVF 122 with the right eye or the left eye can differ depending on the user. Thus, the position at which the nose strikes the operation display unit 126 may vary depending on the user.

Further, if the touch valid area is made to be smaller, the area where erroneous detection occurs is reduced, meanwhile in a case where the user performs a touch-and-movement operation such as a drag operation, there arises a problem that the area where the finger can be moved becomes narrow. Accordingly, it is necessary for the user to perform an operation consciously in such a manner that the user's finger does not get out of the touch valid area, and so the touch operation is restricted. Here, the touch-and-movement operation is an operation of continuously moving the touch position on the operation display unit 126. In one example, the touch-and-movement operation is a drag operation, flick, swipe, or the like. In addition, the touch-and-movement operation may be a multi-touch operation such as pinch.

Thus, with the above circumstances as one viewpoint, the photographing device 10 according to the present embodiment is developed. According to the present embodiment, it is possible to set the range of the touch valid area (or the touch invalid area) in the operation display unit 126 to an area suitable for the user. Then, it is possible for the photographing device 10 to determine whether the touch-and-movement operation is valid on the basis of whether the start point of the touch-and-movement operation is located within the touch valid area. This makes it possible to improve the operability of the touch operation while eliminating or reducing the erroneous detection of the operation on the operation display unit 126.

### 2. Detailed Description of Embodiment

### 2-1. Configuration

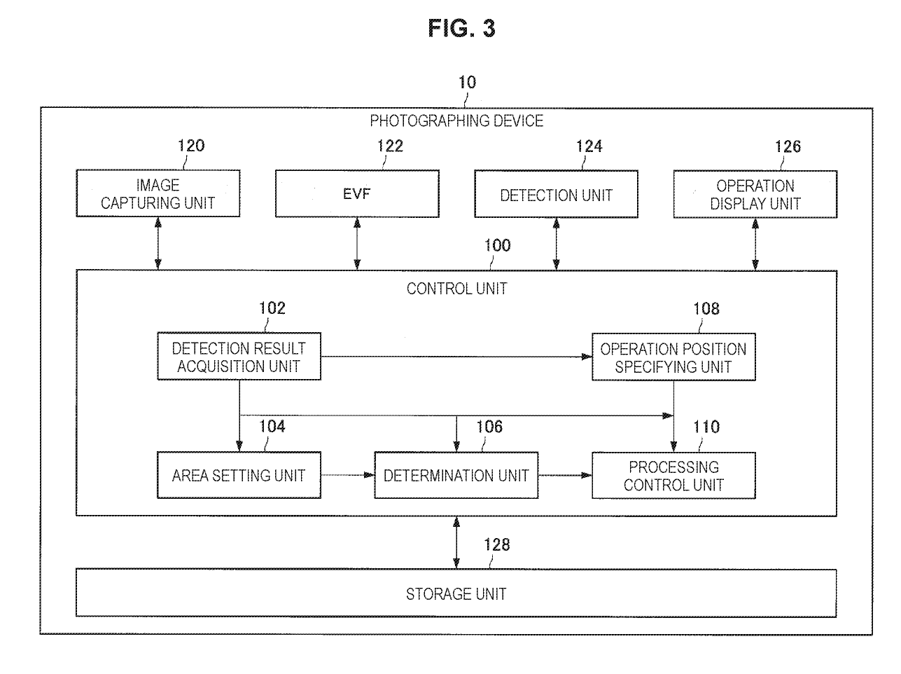

The configuration of the photographing device 10 according to the present embodiment is now described in detail. FIG. 3 is a functional block diagram illustrating the configuration of the photographing device 10 according to the present embodiment. As illustrated in FIG. 3, the photographing device 10 includes a control unit 100, an image capturing unit 120, an EVF 122, a detection unit 124, an operation display unit 126, and a storage unit 128. Moreover, descriptions overlapping with those set forth above will be omitted.

### [2-1-1. Control Unit 100]

The control unit 100 uses the hardware such as a central processing unit (CPU), read only memory (ROM), or random access memory (RAM) built in the photographing device 10 to control the overall operation of the photographing device 10. In addition, as illustrated in FIG. 3, the control unit 100 includes a detection result acquisition unit 102, an area setting unit 104, a determination unit 106, an operation position specifying unit 108, and a processing control unit 110.

### [2-1-2. Detection Result Acquisition Unit 102]

The detection result acquisition unit 102 acquires a detection result as to whether the eye approaches the EVF 122 from the detection unit 124. In addition, the detection result acquisition unit 102 acquires a detection result of the touch operation on the operation display unit 126 from the operation display unit 126.

### [2-1-3. Area Setting Unit 104]

### 2-1-3-1. Setting of Valid Setting Area

The area setting unit 104 sets a valid setting area or an invalid setting area on the operation display unit 126 on the basis of, in one example, a user's input.

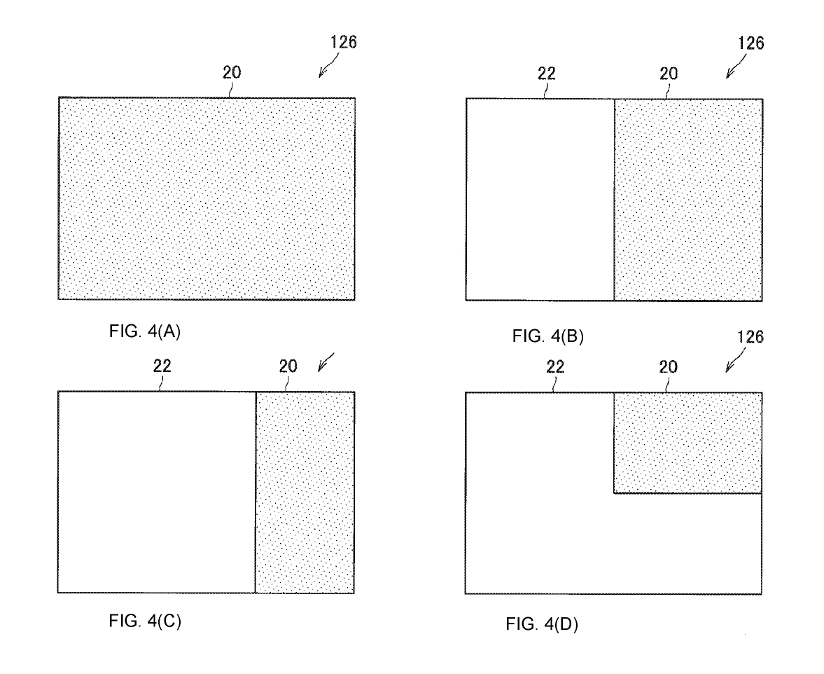

In one example, a plurality of options relating to the range of the valid setting area are presented to the user with the setting menu or the like, and it is possible for the area setting unit 104 to set an area corresponding to an option selected by the user from among these options as the valid setting area. In one example, as illustrated in FIG. 4, the options of “Touch valid for entire area” ((A) in FIG. 4), “Touch valid for only right half” ((B) in FIG. 4), “Touch valid for only right one-third” ((C) in FIG. 4), and “Touch valid for only upper right one-quarter” ((D) in FIG. 4) are presented to the user. Then, the area setting unit 104 sets the area corresponding to an option selected by the user from among these options as the valid setting area (or the invalid setting area).

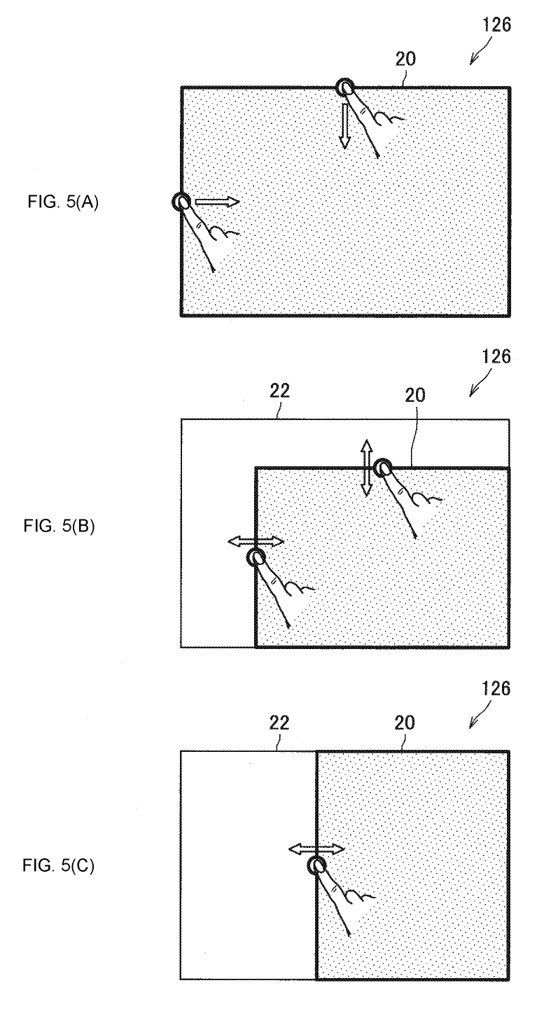

Alternatively, it is also possible for the area setting unit 104 to set an area specified by the touch operation including a drag operation as the valid setting area. In one example, as illustrated in FIG. 5, the area setting unit 104 sets an area specified (optionally) by a drag operation in the setting menu or the like as the valid setting area, and sets an area other than the specified area as the invalid setting area.

Alternatively, in one example, a touch invalid area setting mode for automatically setting the invalid setting area is prepared in advance, and the area setting unit 104 may automatically set the invalid setting area on the basis of proximity of the user's eye to the EVF 122 during the activation of the touch invalid area setting mode. In one example, when the eye approaches the EVF 122, the area setting unit 104 may automatically set an area in a certain range around a portion where the nose strikes the operation display unit 126 as the invalid setting area and set an area other than the invalid setting area as the valid setting area.

### 2-1-3-2. Determination of Valid Area or Invalid Area During Use

Further, after setting the valid setting area (or the invalid setting area), the area setting unit 104 sequentially and automatically sets the touch valid area and the touch invalid area on the operation display unit 126 on the basis of the presence or absence of detection of proximity of the eye to the EVF 122. In one example, in a case where the proximity of the eye to the EVF 122 is detected (hereinafter sometimes referred to as a touchpad mode), the area setting unit 104 sets the valid setting area as the touch valid area and sets an area (or the invalid setting area) other than the valid setting area as the touch invalid area. Alternatively, in the case where the proximity of the eye to the EVF 122 is detected, the area setting unit 104 may set an area other than the invalid setting area as the touch valid area and set the invalid setting area as the touch invalid area.

Further, in a case where the proximity of the eye to the EVF 122 is not detected (hereinafter sometimes referred to as a touch panel mode), the area setting unit 104 sets the entire area of the operation display unit 126 as the touch valid area.

Moreover, in the touch panel mode, a screen is displayed on the operation display unit 126, and the positioning by the touch operation is specified using the absolute position. In addition, in the touchpad mode, basically, a screen of the operation display unit 126 is turned off, and the positioning by the touch operation is specified using the relative position. Moreover, in a modified example, in the touchpad mode, a screen may be displayed on the operation display unit 126.

Furthermore, when the first touch on the operation display unit 126 is detected and the detected touch position is within the touch valid area, the area setting unit 104 changes the touch valid area from the valid setting area to the entire area of the operation display unit 126.

### 2-1-3-3. Change of Valid Setting Area

Moreover, in a modified example, a change mode of the valid setting area is prepared in advance, and so it is also possible for the area setting unit 104 to change the valid setting area on the basis of the touch operation or the like on the operation display unit 126 in the change mode of the valid setting area. In one example, in a case where the determination unit 106 determines that the drag operation performed in the change mode of the valid setting area is valid (described later), the area setting unit 104 may enlarge or reduce the valid setting area depending on the direction and distance of the drag operation.

[2-1-4. Determination unit 106]

### 2-1-4-1. First Determination Example

The determination unit 106 determines the validity of the touch operation on the basis of the detection result of the touch operation that is acquired by the detection result acquisition unit 102 and the touch valid area that is set by the area setting unit 104. In one example, the determination unit 106 determines whether the touch-and-movement operation is valid across the touch valid area and the touch invalid area on the basis of whether the start point of the detected touch-and-movement operation is located within the touch valid area. In one example, in the case where the start point of the detected touch-and-movement operation is located within the touch valid area, the determination unit 106 determines that the touch-and-movement operation is valid.

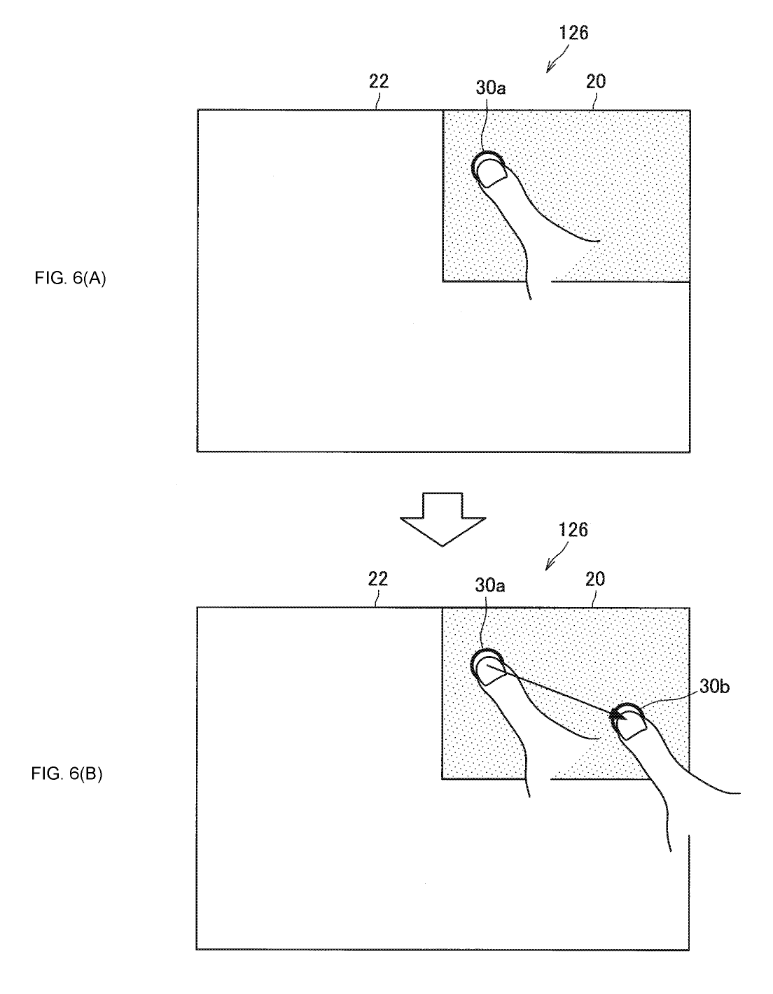

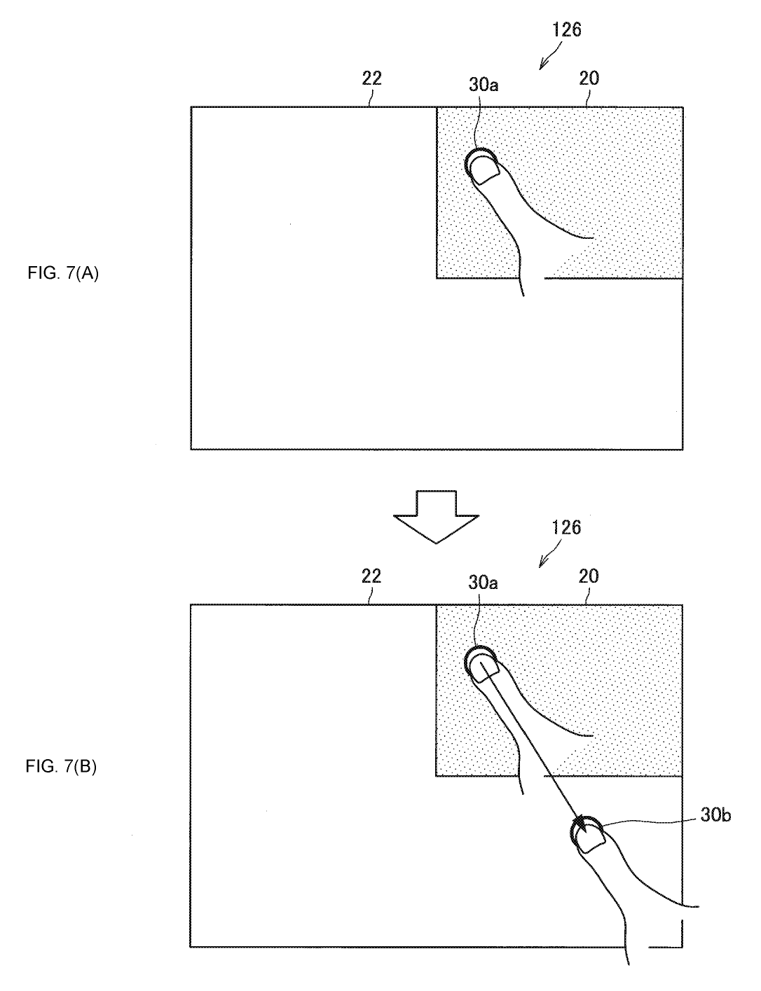

The function described above is now described in more detail with reference to FIGS. 6 and 7. Moreover, FIGS. 6 and 7 are based on the assumption that the upper right one-quarter area of the operation display unit 126 is set as a touch valid area 20 and the other area is set as a touch invalid area 22. In one example, as illustrated in FIG. 6, in a case where a start point 30a of the touch-and-movement operation is located within the touch valid area 20 and the touch position is continuously moved within the touch valid area 20, the determination unit 106 determines that the touch-and-movement operation is valid. In addition, as illustrated in FIG. 7, even in a case where the start point 30a of the touch-and-movement operation is located within the touch valid area 20 and the touch position is moved continuously from the touch valid area 20 to the touch invalid area 22, the determination unit 106 determines that the touch-and-movement operations are (all) valid.

Moreover, in the example illustrated in FIG. 7, in a case where the finger during the touch-and-movement operation is released from the operation display unit 126 in the touch invalid area 22 and then the finger touches again the touch invalid area 22 within a predetermined time, the determination unit 106 may determine that a series of touch-and-movement operations are valid (on the assumption that it is determined that the touch-and-movement operation is continuing).

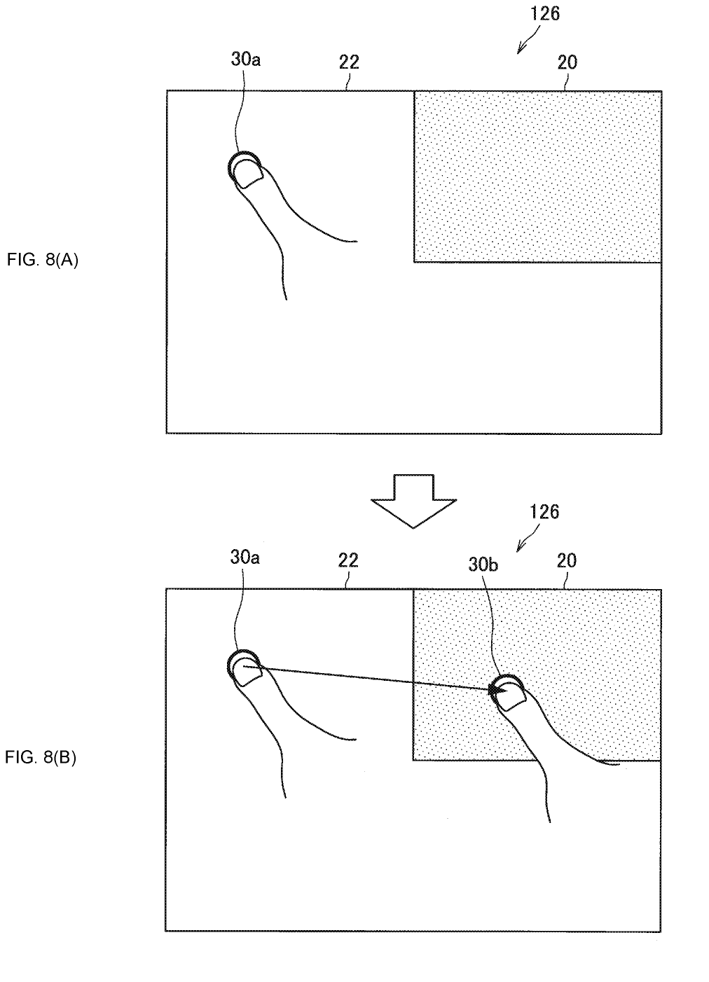

Further, in a case where the start point of the detected touch-and-movement operation is located within the touch invalid area, the determination unit 106 determines that the touch-and-movement operation is invalid. In one example, as illustrated in FIG. 8, in a case where the start point 30a of the touch-and-movement operation is located within the touch invalid area 22 and the touch position is moved continuously from the touch invalid area 22 to the touch valid area 20, the determination unit 106 determines that the touch-and-movement operations are (all) invalid.

### 2-1-4-2. Second Determination Example

Moreover, in a case where the first touch on the touch valid area is detected and then the second touch on the operation display unit 126 is detected, it is also possible for the determination unit 106 to determine that the second touch is invalid. This makes it possible to invalidate the touch that the user does not intend, such as contact of the nose.

Further, in a case where a multi-touch operation such as a pinch is detected, the determination unit 106 determines that the multi-touch operation is valid only in a case where a plurality of touch gestures at the start of the multi-touch operation are located within the touch valid area. This makes it possible to prevent the erroneous detection of the operation.

### 2-1-4-3. First Modified Example

Meanwhile, it is conceivable that the user touches a position slightly deviated from the valid setting area even though the user tries to touch the valid setting area at the start of the touch-and-movement operation. Thus, it is desirable that such an operation can also be determined to be partially valid.

In a modified example, in the case where the start point of the touch-and-movement operation is located within the touch invalid area and the touch position is moved continuously from the touch invalid area to the touch valid area, the determination part 106 may determine that only the operation after movement of the touch position from the touch invalid area to the touch valid area from among the series of touch-and-movement operations is valid.

In one example, only in a case where the start point of the touch-and-movement operation is located within the touch invalid area, the touch position is continuously moved from the touch invalid area to the touch valid area by the touch-and-movement operation, and the movement amount in the touch valid area is equal to or more than a predetermined threshold, the determination unit 106 may determine that the operation after movement of the touch position from the touch invalid area to the touch valid area from among the series of touch-and-movement operations is valid.

### 2-1-4-4. Second Modified Example

Alternatively, in another modified example, the touch valid area, the partial invalid area that is adjacent to the touch valid area, and the touch invalid area that is not adjacent to the touch valid area may be preliminarily classified in the operation display unit 126. In this event, in the case where the start point of the touch-and-movement operation is located within the touch invalid area, the determination unit 106 determines that the touch-and-movement operation is invalid. In addition, in the case where the start point of the touch-and-movement operation is located within the partial invalid area, the determination unit 106 determines that only the operation after movement of the touch position from the partial invalid area to the touch valid area from among the series of touch-and-movement operations is valid. Here, the partial invalid area is an example of the first invalid area in the present disclosure. In addition, the partial invalid area may be defined automatically as a predetermined range around the valid setting area, or the user can specify the range of the partial invalid area using the setting menu or the like.

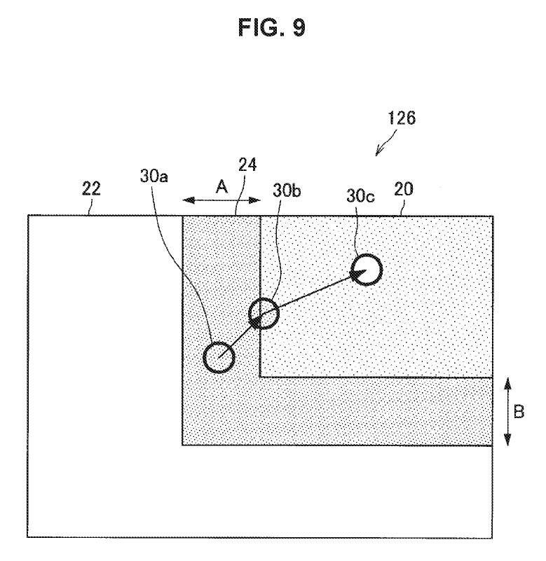

FIG. 9 is a diagram illustrated to describe an example in which the touch valid area 20, the touch invalid area 22, and a partial invalid area 24 are set in the operation display unit 126. In addition, FIG. 9 illustrates an example in a case where the start point 30a of the touch-and-movement operation is located in the partial invalid area 24 and the touch position is moved continuously from the partial invalid area 24 to the touch valid area 20 by the touch-and-movement operation. In this case, the determination unit 106 determines that only the operation after movement of the touch position to the touch valid area among the series of touch-and-movement operations, that is, only the operation from a touch position 30b to a touch position 30c is valid.

### [2-1-5. Operation Position Specifying Unit 108]

The operation position specifying unit 108 specifies an operation position corresponding to the touch position on the operation display unit 126 on the basis of the presence or absence of the detection of the proximity of the eye to the EVF 122. In one example, in the case where the proximity of the eye to the EVF 122 is not detected (in the touch panel mode), the operation position specifying unit 108 specifies the touch position (absolute position) on the operation display unit 126 as the operation position. In addition, in the case where the proximity of the eye to the EVF 122 is detected (in the touchpad mode), the operation position specifying unit 108 specifies the operation position corresponding to the touch position being moved on the basis of the operation position corresponding to the start point of the touch-and-movement operation and a positional relationship between the start point of the touch-and-movement operation and the touch position being moved.

Moreover, as described above, in the touch panel mode, the positioning by the touch operation is specified on the basis of the absolute position, and in the touchpad mode, the positioning by the touch operation is specified on the basis of the relative position, which are different. Thus, in a case where the touch-and-movement operation is in progress and the presence or absence of the detection of the proximity of the eye to the EVF 122 is changed, the operation position specifying unit 108 preferably determines the touch position at the time when the presence or absence of the detection of the proximity of the eye to the EVF 122 is changed as the end point of the touch-and-movement operation.

### [2-1-6. Processing Control Unit 110]

### 2-1-6-1. Processing Regarding Photographing

Movement of Display Position

In the case where the determination unit 106 determines that the touch operation is valid, the processing control unit 110 executes processing regarding the photographing or image reproduction on the basis of the touch operation. In one example, in the case where it is determined that the detected touch-and-movement operation such as a drag operation is valid, the processing control unit 110 moves the display position of the operation target of the touch-and-movement operation. Here, the operation target is, in one example, an object such as an AF frame or a frame of spot automatic exposure (AE).

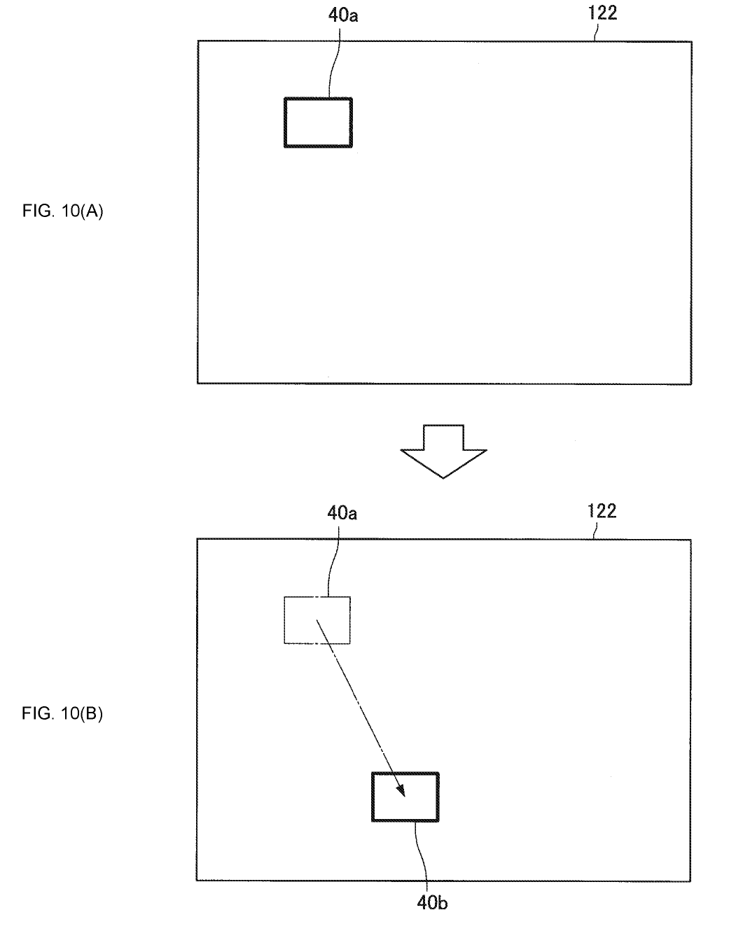

FIG. 10 is a diagram illustrated to describe an example in which an AF frame 40 is moved on the basis of the touch-and-movement operation. In one example, in a case where a drag operation as illustrated in (B) of FIG. 7 is detected, the processing control unit 110 moves the AF frame 40 depending on the direction and distance of the detected drag operation, as illustrated in FIG. 10.

Furthermore, it is also possible for the processing control unit 110 to change the movement speed of the operation target of the touch-and-movement operation on the basis of the presence or absence of the detection of the proximity of the eye to the EVF 122. In one example, the processing control unit 110 increases the movement speed of the operation target of the drag operation in the case where the proximity of the eye is detected, as compared with the case where the proximity of the eye to the EVF 122 is not detected.

As described above, in the case where the proximity of the eye to the EVF 122 is detected, the touch valid area is set only in a part of the area (the valid setting area). According to this control example, in the case where the proximity of the eye to the EVF 122 is detected, it is possible to move significantly the operation target simply by slightly moving the touch position. This eliminates the necessity for the user to perform the drag operation many times to move the operation target to a desired position (even in the case where the touch valid area is set to be narrow).

Enlargement of Display Size

Further, in the case where the detected touch-and-movement operation such as a pinch is determined to be valid, it is also possible for the processing control unit 110 to enlarge or reduce, in one example, the display size of the operation target such as the AF frame.

Change in Focus

Alternatively, in a case where the detected touch-and-movement operation such as a swipe is determined to be valid, the processing control unit 110 may change the focus position in real time depending on the detected touch-and-movement operation. In one example, the processing control unit 110 may change the focus position on the basis of the simulation of multi-lens based light rays (computational photography) and the detected touch-and-movement operation.

Moreover, in a modified example, there may be a case where the drag operation (valid) of the first finger on the operation display unit 126 is performed and then the additional drag operation of the second finger is detected while holding the touch on the operation display unit 126 at the time of stopping the first finger's drag operation. In this case, the processing control unit 110 may execute different processing for the first finger's drag operation and the second finger's drag operation. In one example, the processing control unit 110 may change the movement speed of the same operation target for the first finger's drag operation and the second finger's drag operation. In one example, the processing control unit 110 may move the operation target faster on the basis of the first finger's drag operation, and then move the same operation object slower on the basis of the second finger's drag operation. According to this control example, it is possible for the user to move initially the position of the operation target largely and then adjust the position of the operation target finely.

Alternatively, the processing control unit 110 moves the position of the operation target on the basis of the first finger's drag operation, and then may change the size of the same operation target on the basis of the second finger's drag operation.

### 2-1-6-2. Processing Regarding Image Reproduction

Further, in the case where the determination unit 106 determines that the touch operation is valid, it is possible for the processing control unit 110 to execute the processing regarding image reproduction on the basis of the touch operation. In one example, in the case where the determination unit 106 determines that the detected touch-and-movement operation such as a swipe is valid, the processing control unit 110 switches the image being reproduced. Alternatively, when the determining unit 106 determines that the detected touch-and-movement operation such as a pinch is valid, the processing control unit 110 causes the image being reproduced to be displayed in an enlarged (or reduced) manner.

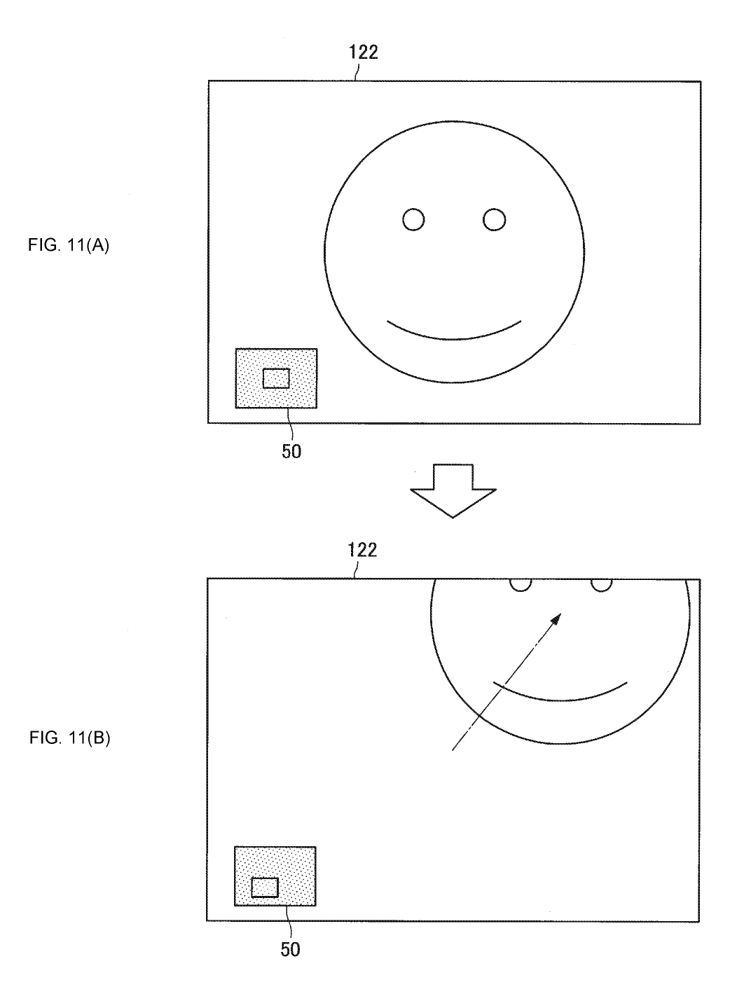

Alternatively, in a case where the determination unit 106 determines that the detected drag operation is valid at the time when the image is displayed in the EVF 122 in an enlarged manner, the processing control unit 110 moves the display position of the image being displayed in an enlarged manner on the basis of the detected drag operation, as illustrated in FIG. 11.

Alternatively, in one example, in a case of detecting an operation of tracing the operation display unit 126 to draw an arc with the finger, the processing control unit 110 rotates the image being reproduced. Alternatively, in a case where the determination unit 106 determines that the detected touch-and-movement operation such as a flick is valid, the processing control unit 110 may, in one example, execute a rating on the image being reproduced, processing of deleting the image being reproduced, processing of transferring the image being reproduced to another device such as smartphones, or the like. According to these control examples, in a case where the image is being reproduced by looking it through the EVF 124 due to, in one example, dazzling sunlight, the user can execute various types of processing with ease of operation.

Alternatively, in the case where the determination unit 106 determines that the touch operation is valid, it is also possible for the processing control unit 110 to perform the image editing processing. In one example, the processing control unit 110 may add some effects such as attaching an image having a small size to a position corresponding to the touch position in the image being reproduced.

### 2-1-6-3. Switching Between Modes

Further, in the case where the determination unit 106 determines that the touch operation is valid, the processing control unit 110 can also switch a mode being activated on the basis of the touch operation. In one example, in a case where a valid double tap is detected while the proximity of the eye to the EVF 122 is being detected, the processing control unit 110 may switch a setting mode of the focus position. In one example, there are prepared three types of setting mode, that is, a setting mode for adjusting the focus to the entire screen, a setting mode for adjusting the focus to the center of the screen, and a setting mode for adjusting the focus to a position corresponding to the touch position are provided, and the processing control unit 110 may perform switching between these setting modes each time the valid double tap is detected.

Further, the processing control unit 110 switches the mode of the operation display unit 126 between the touch panel mode and the touchpad mode depending on whether the eyes approach the EVF 122.

### 2-1-6-4. Control of Display

Further, it is possible for the processing control unit 110 to cause various types of displays such as a warning display to be displayed on the EVF 122 or the operation display unit 126. In one example, in a case where the touch operation is valid in the touch panel mode and the touch operation is invalid in the touchpad mode, the processing control unit 110 causes a warning display indicating such conditions to be displayed on the EVF 122 or the operation display unit 126.

Alternatively, when the determination unit 106 determines that the detected touch operation is invalid, the processing control unit 110 may cause a display indicating that the touch operation is invalid (e.g., a predetermined image or a predetermined color of light) to be displayed on the EVF 122 or the operation display unit 126. Alternatively, when the determination unit 106 determines whether the detected touch operation is valid, the processing control unit 110 may cause a display indicating the determination result obtained by the determination unit 106 to be displayed on the EVF 122 or the operation display unit 126.

Alternatively, when the proximity of the eye to the EVF 122 is detected, the processing control unit 110 may cause a screen illustrating the positional relationship between the entire operation display unit 126 and the touch valid area to be displayed on the EVF 122, in one example, for a predetermined time. This makes it possible for the user to recognize the position of the touch valid area on the operation display unit 126 while looking through the EVF 122.

### [2-1-7. Image Capturing Unit 120]

The image capturing unit 120 photographs an image by causing an image sensor such as charge coupled device (CCD) or complementary metal oxide semiconductor (CMOS) to form an image of an external picture through a lens.

### [2-1-8. Detection Unit 124]

The detection unit 124 detects the use state or the like of the photographing device 10 by the user. In one example, the detection unit 124 detects whether the eye approaches the EVF 122 using infrared rays or the like. In one example, in a case where an infrared sensor detects an object near the EVF 122, the detection unit 124 determines that the eye is approaching the EVF 122. In other words, the detection unit 124 does not necessarily determine whether the object (approaching the EVF 122) is the eye.

### [2-1-9. Storage Unit 128]

The storage unit 128 stores various data such as images and various types of software.

Moreover, the configuration of the photographing device 10 according to the present embodiment is not limited to the configuration described above. In one example, in a case where the EVF 122 itself (instead of the detection unit 124) is capable of detecting whether the eye approaches the EVF 122, the detection unit 124 is not necessarily included in the photographing device 10.

### 2-2. Operation

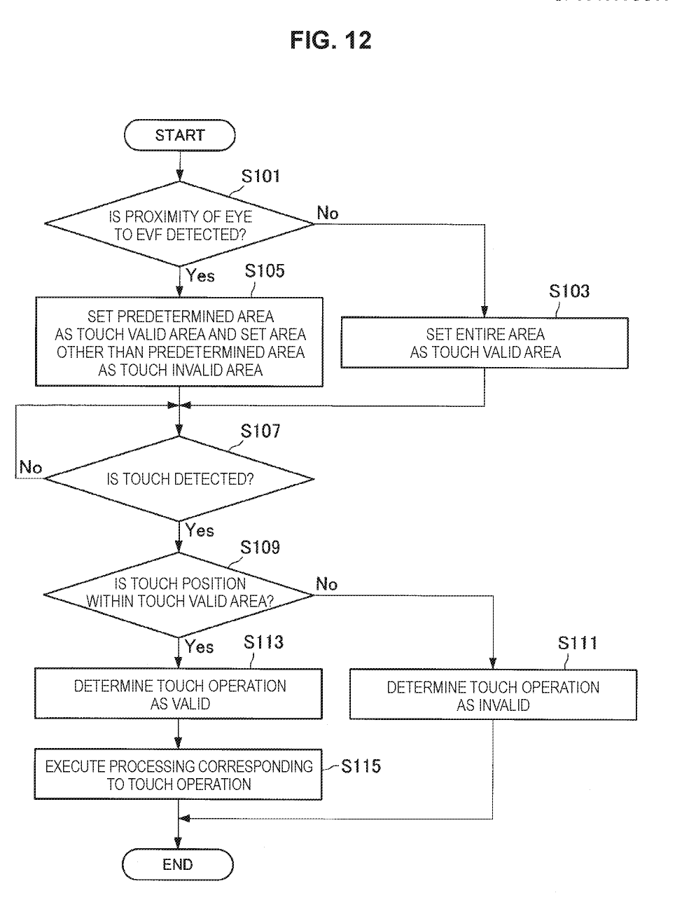

The configuration of the present embodiment is described above. An example of the operation of the present embodiment is now described with reference to FIG. 12. As illustrated in FIG. 12, the detection unit 124 of the photographing device 10 first detects whether the eye approaches the EVF 122 (S101). If the proximity of the eye to the EVF 122 is not detected (No in S101), then the area setting unit 104 sets the entire area of the operation display unit 126 as the touch valid area (S103). Then, the photographing device 10 performs the processing of S107 to be described later.

On the other hand, if the proximity of the eye to the EVF 122 is detected (Yes in S101), then the area setting unit 104 sets the preset valid setting area as the touch valid area and sets an area other than the valid setting area as the touch invalid area (S105).

Subsequently, the determination unit 106 determines whether a touch on the operation display unit 126 is detected (S107). If no touch is detected (No in S107), the determination unit 106 again performs the processing of S107, in one example, after a certain period of time has elapsed.

On the other hand, if a touch is detected (Yes in S107), then the determination unit 106 checks whether the detected touch position is within the touch valid area that is set in S103 or S105 (S109). If the detected touch position is out of the touch valid area (i.e., within the touch invalid area) (No in S109), then the determination unit 106 determines that the touch operation detected in S107 is invalid (S111). Then, the photographing device 10 ends this processing.

On the other hand, if the detected touch position is within the touch valid area (Yes in S109), then the determination unit 106 determines that the touch operation detected in S107 is valid (S113). Then, the processing control unit 110 executes the processing corresponding to the detected touch operation (S115).

### 2-3. Advantageous Effects

As described above, it is possible for the photographing device 10 according to the present embodiment to set the range of the touch valid area (or the touch invalid area) in the operation display unit 126 to an area suitable for the user, in one example, on the basis of the user's input. Then, the photographing device 10 determines whether the touch-and-movement operation is valid across the touch valid area and the touch invalid area, on the basis of whether the start point of the touch-and-movement operation is located within the touch valid area. Thus, it is possible to improve the operability of the touch operation while eliminating or reducing the erroneous detection of the touch operation on the operation display unit 126.

In one example, an area suitable for the user (relevant user) can be set in advance as the touch valid area. Thus, even if the nose strikes the operation display section 126 or the finger of the hand that holds the photographing device 10 touches the operation display section 126 without the intention of the user, it is possible for the photographing device 10 to determine that such contact is invalid.

Further, in one example, in the case where the start point of the touch-and-movement operation such as the drag operation is located within the touch valid area, the photographing device 10 determines that the touch-and-movement operation is valid across the touch valid area and the touch invalid area. Thus, in the case where the touch-and-movement operation is performed, the area in which the finger can be moved is not narrowed, and the touch operation on the operation display unit 126 is not restricted. Thus, comfortable operability can be provided to the user. In one example, it is possible for the user to perform the touch-and-movement operation without being conscious of the touch valid area.

### 3. Modified Examples

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

### 3-1. First Modified Example

In one example, in a case where the photographing device 10 is capable of detecting which of the left and right eyes approaches the EVF 122, the photographing device 10 may dynamically change the touch valid area depending on whether the approaching eye is the right eye or left eye. In one example, the photographing device 10 may set the valid area to be smaller for the case where the eye approaching the EVF 122 is the left eye (rather than the right eye).

Alternatively, in the case where the photographing device 10 is capable of detecting the position of the nose when the eye approaches the EVF 122, the photographing device 10 may set dynamically the range of the valid area depending on the detected position of the nose.

### 3-2. Second Modified Example

Further, the present disclosure is applicable to medical applications, and the control device in the present disclosure may be medical instruments such as high-tech microscope. In one example, the present disclosure is applicable to a field in which a user operates a touch display as a touchpad while a user brings his/her eye close to a microscope or an endoscope (a finder thereof). In an example, the medical instrument may display the enlarged (or reduced) image depending on the touch-and-movement operation on the touch display, move the display position of the image being enlarged, or change various photographing parameters such as focus position.

### 3-3. Third Modified Example

Further, the above embodiment describes the example in which the control device in the present disclosure is the photographing device 10, but it is not limited to this example. In one example, the control device in the present disclosure may be a mobile phone such as smartphones, a tablet terminal, a personal computer (PC), a game console, or the like.

Further, according to the embodiment described above, it is also possible to provide a computer program for causing hardware such as a CPU, a ROM, and a RAM to execute functions equivalent to the respective configurations of the photographing device 10 according to the embodiment described above. In addition, a recording medium having the computer program recorded thereon is also provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A control device including:

a determination unit configured to determine whether a touch-and-movement operation is valid across a valid area in which a touch operation on a display unit is treated as valid and an invalid area in which the touch operation is treated as invalid on a basis of whether a start point of the touch-and-movement operation is located within the valid area.

(2)

The control device according to (1),

in which the determination unit, in a case where the start point of the touch-and-movement operation is located within the valid area, determines that the touch-and-movement operation is valid.

(3)

The control device according to (1) or (2),

in which the determination unit, in a case where the start point of the touch-and-movement operation is located within the invalid area, determines that the touch-and-movement operation is invalid.

(4)

The control device according to (1) or (2),

in which the determination unit, in a case where the start point of the touch-and-movement operation is located within the invalid area, determines that only an operation after movement of a touch position from the invalid area to the valid area among the touch-and-movement operations is valid.

(5)

The control device according to (1) or (2),

in which the invalid area is divided into a first invalid area that is adjacent to the valid area and a second invalid area that is not adjacent to the valid area,

the determination unit, in a case where the start point of the touch-and-movement operation is located within the second invalid area, determines that the touch-and-movement operation is invalid, and

the determination unit, in a case where the start point of the touch-and-movement operation is located within the first invalid area, the determination unit determines that only an operation after movement of a touch position from the first invalid area to the valid area among the touch-and-movement operations is valid.

(6)

The control device according to any one of (1) to (5), further including:

an area setting unit configured to set the valid area and the invalid area on the display unit on a basis of presence or absence of detection of proximity of an eye to a finder.

(7)

The control device according to (6),

in which the area setting unit, in a case where the proximity of the eye to the finder is detected, sets a predetermined area on the display unit as the valid area and sets an area other than the predetermined area on the display unit as the invalid area.

(8)

The control device according to (6) or (7),

in which the area setting unit, in a case where the proximity of the eye to the finder is not detected, sets an entire area of the display unit as the valid area.

(9)

The control device according to any one of (1) to (8),

in which the touch-and-movement operation is a drag operation on the display unit.

(10)

The control device according to any one of (1) to (9),

in which the touch-and-movement operation is an operation used to specify a position to be focused.

(11)

The control device according to any one of (1) to (10), further including:

an operation position specifying unit configured to specify an operation position corresponding to a touch position being moved by the touch-and-movement operation on a basis of presence or absence of detection of proximity of an eye to a finder.

(12)

The control device according to (11),

in which the operation position specifying unit, in a case where the proximity of the eye to the finder is detected, specifies the touch position being moved as the operation position.

(13)

The control device according to (11) or (12),

in which the operation position specifying unit, in a case where the proximity of the eye to the finder is not detected, specifies the operation position on a basis of an operation position corresponding to the start point of the touch-and-movement operation and a positional relationship between the start point of the touch-and-movement operation and the touch position being moved.

(14)

The control device according to any one of (11) to (13),

in which the operation position specifying unit, in a case where the presence or absence of the detection of the proximity of the eye to the finder is changed, determines a touch position when the presence or absence of the detection of the proximity of the eye to the finder is changed as an end point of the touch-and-movement operation.

(15)

The control device according to any one of (1) to (14), further including:

a processing control unit configured to execute processing regarding photographing or image reproduction, in a case where the touch-and-movement operation is determined as valid by the determination unit, on a basis of the touch-and-movement operation.

(16)

The control device according to (15),

in which the processing control unit moves a display position of an operation target of the touch-and-movement operation that is displayed on a finder or the display unit on the basis of the touch-and-movement operation.

(17)

The control device according to (16),

in which the processing control unit changes a moving speed of the operation target of the touch-and-movement operation further on a basis of presence or absence of detection of proximity of an eye to the finder.

(18)

The control device according to any one of (15) to (17),

in which the processing control unit causes a to be displayed on a finder or the display unit, the display indicating that validity of a touch operation on the display unit is changed further depending on whether an eye approaches the finder.

(19)

A control method including:

determining whether a touch-and-movement operation is valid across a valid area in which a touch operation on a display unit is treated as valid and an invalid area in which the touch operation is treated as invalid on a basis of whether a start point of the touch-and-movement operation is located within the valid area.

(20)

A program causing a computer to function as:

a determination unit configured to determine whether a touch-and-movement operation is valid across a valid area in which a touch operation on a display unit is treated as valid and an invalid area in which the touch operation is treated as invalid on a basis of whether a start point of the touch-and-movement operation is located within the valid area.

### REFERENCE SIGNS LIST

10 photographing device
100 control unit
102 detection result acquisition unit
104 area setting unit
106 determination unit
108 operation position specifying unit
110 processing control unit
120 image capturing unit
122 EVF
124 detection unit
128 storage unit

1. A control device comprising:
a determination unit configured to determine whether a touch-and-movement operation is valid across a valid area in which a touch operation on a display unit is treated as valid and an invalid area in which the touch operation is treated as invalid on a basis of whether a start point of the touch-and-movement operation is located within the valid area.

2. The control device according to claim 1,
wherein the determination unit, in a case where the start point of the touch-and-movement operation is located within the valid area, determines that the touch-and-movement operation is valid.

3. The control device according to claim 1,
wherein the determination unit, in a case where the start point of the touch-and-movement operation is located within the invalid area, determines that the touch-and-movement operation is invalid.

4. The control device according to claim 1,
wherein the determination unit, in a case where the start point of the touch-and-movement operation is located within the invalid area, determines that only an operation after movement of a touch position from the invalid area to the valid area among the touch-and-movement operations is valid.

5. The control device according to claim 1,
wherein the invalid area is divided into a first invalid area that is adjacent to the valid area and a second invalid area that is not adjacent to the valid area,
the determination unit, in a case where the start point of the touch-and-movement operation is located within the second invalid area, determines that the touch-and-movement operation is invalid, and
the determination unit, in a case where the start point of the touch-and-movement operation is located within the first invalid area, the determination unit determines that only an operation after movement of a touch position from the first invalid area to the valid area among the touch-and-movement operations is valid.

6. The control device according to claim 1, further comprising:
an area setting unit configured to set the valid area and the invalid area on the display unit on a basis of presence or absence of detection of proximity of an eye to a finder.

7. The control device according to claim 6,
wherein the area setting unit, in a case where the proximity of the eye to the finder is detected, sets a predetermined area on the display unit as the valid area and sets an area other than the predetermined area on the display unit as the invalid area.

8. The control device according to claim 6,
wherein the area setting unit, in a case where the proximity of the eye to the finder is not detected, sets an entire area of the display unit as the valid area.

9. The control device according to claim 1,
wherein the touch-and-movement operation is a drag operation on the display unit.

10. The control device according to claim 1,
wherein the touch-and-movement operation is an operation used to specify a position to be focused.

11. The control device according to claim 1, further comprising:
an operation position specifying unit configured to specify an operation position corresponding to a touch position being moved by the touch-and-movement operation on a basis of presence or absence of detection of proximity of an eye to a finder.

12. The control device according to claim 11,
wherein the operation position specifying unit, in a case where the proximity of the eye to the finder is detected, specifies the touch position being moved as the operation position.

13. The control device according to claim 11,
wherein the operation position specifying unit, in a case where the proximity of the eye to the finder is not detected, specifies the operation position on a basis of an operation position corresponding to the start point of the touch-and-movement operation and a positional relationship between the start point of the touch-and-movement operation and the touch position being moved.

14. The control device according to claim 11,
wherein the operation position specifying unit, in a case where the presence or absence of the detection of the proximity of the eye to the finder is changed, determines a touch position when the presence or absence of the detection of the proximity of the eye to the finder is changed as an end point of the touch-and-movement operation.

15. The control device according to claim 1, further comprising:
a processing control unit configured to execute processing regarding photographing or image reproduction, in a case where the touch-and-movement operation is determined as valid by the determination unit, on a basis of the touch-and-movement operation.

16. The control device according to claim 15,
wherein the processing control unit moves a display position of an operation target of the touch-and-movement operation that is displayed on a finder or the display unit on the basis of the touch-and-movement operation.

17. The control device according to claim 16,
wherein the processing control unit changes a moving speed of the operation target of the touch-and-movement operation further on a basis of presence or absence of detection of proximity of an eye to the finder.

18. The control device according to claim 15,
wherein the processing control unit causes a to be displayed on a finder or the display unit, the display indicating that validity of a touch operation on the display unit is changed further depending on whether an eye approaches the finder.

19. A control method comprising:
determining whether a touch-and-movement operation is valid across a valid area in which a touch operation on a display unit is treated as valid and an invalid area in which the touch operation is treated as invalid on a basis of whether a start point of the touch-and-movement operation is located within the valid area.

20. A program causing a computer to function as:
a determination unit configured to determine whether a touch-and-movement operation is valid across a valid area in which a touch operation on a display unit is treated as valid and an invalid area in which the touch operation is treated as invalid on a basis of whether a start point of the touch-and-movement operation is located within the valid area.
